(19) United States
(12) Patent Application Publication
(10) Pub. No.: US 2007/0011160 A1
(43) Pub. Date: Jan. 11, 2007

(54) Literacy automation software

(76) Inventors: Denis Ferland, Indianapolis, IN (US); Edwin A. Reynolds, Indianapolis, IN (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/316,097

(22) Filed: Dec. 21, 2005

Related U.S. Application Data
(60) Provisional application No. 60/697,207, filed on Jul. 7, 2005.

(51) Int. Cl. G06F 17/30

(52) U.S. Cl. 707/6

(57) ABSTRACT

A method for creating and automating text definitions comprising the following steps: selecting a word to be defined; selecting a plurality of dictionaries and comparing the word to content of the dictionary; determining the root of the word; creating a list of words, including the root; and creating a plurality of related words from the root.

### CROSS REFERENCE TO RELATED APPLICATIONS

This application claims benefit and priority from provisional application No. 60/697,207, filed Jul. 7, 2005, entitled, “Literacy Automation Software,” which is incorporated by reference herein in its entirety.

### FIELD OF THE INVENTION

The present invention is directed to the field of literacy software. In particular the present invention enables users to derive a definition from machine readable text by automating the process of doing lookups in multiple dictionaries through the process of clicking or “hyper-selecting” words.

### BACKGROUND OF THE INVENTION

With the proliferation of the Internet, users are frequently confronted with new and unfamiliar words, terms and expressions. Scientists and engineers are continuously confronted with journals and papers that are filled with technical jargon. Government agencies produce voluminous reports with special terms and acronyms.

Many of these documents are written by persons familiar with technology or a specialized topic but are not necessarily written by technical writers. Therefore, these documents are not written in a manner sympathetic to one who is unfamiliar with the subject matter. The documents tend to have many undefined terms that may include cryptic and undefined terms and acronyms. It may be difficult or impossible to read and comprehend a document with undefined terms.

The problem of simplifying technical and specialized papers and articles grows steadily worse as technology marches onward. Although many corporations and businesses have attempted to incorporate open standards into their products, which results in some terms for proprietary technology becoming obsolete and unused, the number of special terms continues to increase rather than decrease. Technological growth has spurred more technological innovation that requires special words to be coined for new concepts. As a result, more special terms or words are created.

This problem has led to the creation of a variety of so-called literacy software packages and tools which assist users in understanding new or unfamiliar terms and words. The simplest of these is dictionary icons which form part of browsers and the like. These simple tools simply permit a user to type in a word which is then looked up in a static dictionary. A number of patents have issued in the area of literacy software and systems.

U.S. Pat. No. 5,553,184 discloses a computer system for dynamically generating a set of display panels which will provide a user friendly interactive user interface for I/O as the steps in an application program requiring user interaction are carried out. The system involves a PC or workstation display having a display management system providing a set of rules and constraints governing the layout of each screen panel. The system stores data sufficient to support each of a plurality of basic screen panels. As the program proceeds and each of the program steps is carried out, the system modifies the data supporting a selected one of the basic panels to provide the modified screen panel required for the user interface with respect to each particular application program step. The modification of each particular screen panel is based at least in part on data entered into the system through interfaces provided by the screen panel required for previous steps in the application program. The modification involves at least in part the calculation of the orthogonal coordinates of components or elements in the particular screen layout.

U.S. Pat. No. 6,697,089 discloses an improved communications interface between a human and a computer be provided, the interface to the computer program is directed to accommodate the variabilities of human communication rather than accommodate the rigid structure of syntax, grammar, and semantics normally used in communications with a computer. A computer program human interaction dialog is customized by detecting a need of the computer program to present knowledge to a user in human perceptible form and providing options of grammar and semantics for describing the knowledge. These options of grammar and semantics are presented as a choice to the user. The user's choice is saved for later use when the knowledge itself is presented.

U.S. Pat. No. 5,251,129 is directed towards a trainable method of extracting keywords of one or more words is disclosed. According to the method, every word within a document that is not a stop word is stemmed and evaluated and receives a score. The scoring is performed based on a plurality of parameters which are adjusted through training prior to use of the method for keyword extraction. Each word having a high score is then replaced by a word phrase that is delimited by punctuation or stop words. The word phrase is selected from word phrases having the stemmed word therein. Repeated keywords are removed. The keywords are expanded and capitalization is determined. The resulting list forms extracted keywords.

U.S. Pat. No. 6,470,307 is directed towards a trainable method of extracting keywords of one or more words. According to the method, every word within a document that is not a stop word is stemmed and evaluated and receives a score. The scoring is performed based on a plurality of parameters which are adjusted through training prior to use of the method for keyword extraction. Each word having a high score is then replaced by a word phrase that is delimited by punctuation or stop words. The word phrase is selected from word phrases having the stemmed word therein. Repeated keywords are removed. The keywords are expanded and capitalization is determined. The resulting list forms extracted keywords.

U.S. Pat. No. 6,823,301 discloses a system which analyzes a language correctly. It divides a given sentence into the token and it fixes a part of speech. As for the token which can not be fixed as one part of speech, it decides by the part of speech of back and forth the token. As for the predicate, it analyzes an attribute using suffix and so on. Next, it corresponds in the role and the part of speech. Then, it does the analysis of the local structure and the decision of the role. After that, it analyzes the whole structure by the extraction of the subordinate sentence and the sentence pattern analysis and so on. By the analysis of the whole structure, it corrects if it is necessary to correct local structure.

U.S. Pat. No. 6,415,250 discloses a language identification system for automatically identifying a language in which an input text is written based upon a probabilistic analysis of predetermined portions of words sampled from the input text. The predetermined portions of words reflect morphological characteristics of natural languages. The automatic language identification system determines which language of a plurality of represented languages a given text is written based upon a value representing the relative likelihood that the text is a particular one of the plurality of represented languages due to a presence of a morphologically-significant word portion in the text. Preferably the word portion is the last three characters in a word. The relative likelihood is derived from a relative frequency of occurrence of the fixed-length word ending in each of a plurality of language corpuses, within each language corpus corresponding to one of the plurality of represented languages. Specifically, the automatic language identification system includes a language corpus analyzer that generates, for each of a plurality of word endings extracted from at least one of the language corpuses, a plurality of probabilities associated with the word ending and one of the plurality of represented languages. Each of the language corpuses represents a natural language and each of the probabilities represents a relative likelihood that the text is the associated language due to the presence of the associated word ending in the text. The relative likelihood is derived from a relative frequency that the associated word ending occurs in each of the plurality of language corpuses. The automatic language identification system also comprises a language identification engine that determines, for each of the represented languages, an arithmetic sum of the relative probabilities for all the word endings which appear in the text. The source language is determined to be the represented language having the greatest arithmetic sum of relative probabilities, provided this sum exceeds zero.

U.S. Pat. No. 6,216,123 discloses a method and system for generating and searching a full text index. The fill text index includes the use of word numbers and a minimum delta which minimizes the need to access document level information during the application of search operators. Word registers having coordinated document level and word level information, as well as relevance information are used in search operations. Word numbers are clustered together during sub-operations in preparation for the next operation in a search query. The fill text index according to the present invention is extremely efficient and greatly reduces table accesses and/or disk I/Os.

U.S. Pat. No. 5,724,594 discloses a method and system for determining the derivational relatedness of a derived word and a base word. In a preferred embodiment, the system includes a machine-readable dictionary containing entries for head words and morphemes. Each entry contains definitional information and semantic relations. Each semantic relation specifies a relation between the head word with a word used in its definition. Semantic relations may contain nested semantic relations to specify relations between words in the definition. The system compares the semantic relations of the derived word to the semantic relations of a morpheme, which is putatively combined with the base word when forming the derived word. The system then generates a derivational score that indicates the confidence that the derived word derives from the base word.

U.S. Pat. No. 6,466,926 is directed towards a discriminant function is defined by conventional learning discriminant analysis (22) and a value of the discriminant function is calculated (23) for all the training patterns in the in-category pattern set of each category and for all the training patterns in the in-category rival pattern set of the category. The in-category pattern set is composed of all the training patterns defined as belonging to the category. The rival pattern set is composed of the training patterns that belong to other categories and that are incorrectly recognized as belonging to the category. An in-category pattern subset and a rival pattern subset are then formed (24) for each category. The in-category pattern subset for the category is formed by selecting a predetermined number of the training patterns that belong to the in-category pattern set and that, among the training patterns that belong to the in-category pattern set, have the largest values of the discriminant function. The rival pattern subset for the category is formed by selecting a predetermined number of the training patterns that belong to the rival pattern set of the category and that, among the training patterns that belong to the rival pattern set, have the smallest values of the discriminant function. A linear discriminant analysis operation is then performed (25) on the in-category pattern subset and the rival pattern subset to obtain parameters defining a new discriminant function. The reference vector and weighting vector stored in the recognition dictionary for the category are then modified using the parameters defining the new discriminant function.

U.S. Pat. No. 5,675,705 discloses a speech recognizing device performing speech syllable recognition and language word identification. The speech syllable recognition is performed on an ensemble composed of nearly one thousand syllables formed by the human vocal system, which allows for variations caused by language dialects and speech accents. For syllable recognition, the nearly one thousand speech syllables, using a spectrogram-feature-based approach, are parsed in a hierarchical structure based on the region of the vocal system from where the syllable emanated from, root syllable from that vocal region, vowel-caused variation of the root syllable, and syllable duration. The syllable's coded representation includes sub-codes for each of the levels of this hierarchical structure. For identification, speech words composed of sequences of coded syllables are mapped to known language words and their grammatical attribute, using a syllabic dictionary where the same words spoken differently map to a known language word.

U.S. Pat. No. 5,832,480 discloses descriptive canonical forms of entity types are created by scanning one or more documents in a database of a computer system to identify one or more proper names that appear in the documents as raw names. Each of the raw names has zero or more proper names, zero or more medial substrings, zero or more leading substrings, and zero or more trailing substrings. The raw names of one or more documents are “cleaned” and “split” until certain “cleaning and splitting conditions” are no longer met to obtain a list of clean and split candidate names. Anchor names are selected from the list that unambiguously represent an entity type. The anchor names have one or more entity-type attribute values. Variant names, clean and split candidate names having one or more shared attribute (values) with the anchor name, are combined with the anchor name to create an equivalence group of names that refer to the same entity. A canonical form is generated for the group from a subset of the anchor name attributes. A canonical form is created in this manner for all of the clean and split candidate names on the list.

U.S. Pat. No. 5,995,922 is directed towards a method and system for retrieving information from an electronic dictionary. The system stores all information about words that have the same normalized form into a single entry within the electronic dictionary. The normalized form of a word has all lower case letters and no diacritical marks. When information is to be retrieved from the dictionary for a word, the word is first normalized and then the dictionary is searched for the entry corresponding to that normalized word. The entry that is found contains the information for that word.

U.S. Patent Application No. 20040210435 discloses a dictionary retrieval processing by the electronic dictionary, if a headword matching a retrieval object word is not stored in a built-in dictionary data, the retrieval object word is registered in the form of a network-dictionary retrieval object listing. If a network dictionary retrieval is performed through connection to the dictionary server, a dictionary storing the registered retrieval word is retrieved in the dictionary server, is transmitted to the electronic dictionary, and is displayed. When the displayed dictionary in the network dictionary retrieval is selected, dictionary data is retrieved from the target of the selected dictionary; the dictionary contents corresponding to the retrieval word retrieved in the dictionary server is transmitted to the user electronic dictionary and is displayed. When update of a dictionary is instructed, data of the dictionary is transmitted and downloaded into the dictionary server, and built-in dictionary data is thereby updated and stored.

U.S. Patent Application No. 20040187084 discloses a method and apparatus for a central dictionary and glossary server. An application executing on a client is able to access a local copy of a dictionary or glossary. A master dictionary or glossary is updated at a server, and the update to the master dictionary or glossary is served to the application on the client to update the local copy of the dictionary or glossary. A datastream may also be processed by automatically scanning a datastream and automatically detecting, in the datastream, a word that cannot be matched to a word in a dictionary or glossary. The unmatched word is identified as an acronym, and in response, data associated with the acronym, selected from a hierarchical set of glossaries, is inserted into the datastream in close proximity to the acronym. In another aspect of processing a datastream, in response to an indication that the unmatched word is a properly spelled new term, a dictionary or glossary may be updated with the new term, and the dictionary or glossary is a member of a hierarchically ordered set of dictionaries and/or glossaries. The system may also contain an organizational database comprising information for organizational units associated with a data processing system, and each glossary in the hierarchical set of glossaries is associated with an organizational unit.

U.S. Patent Application No. 20040153311 discloses a computer system and methods, apparatus and systems for building concept knowledge from a machine-readable dictionary. The machine-readable dictionary includes a plurality of words in a first language and a plurality of corresponding translated words in a second language, and a plurality of words in the second language and a plurality of corresponding translated words in the first language. The method comprises steps of providing a seed word in the first language; forward-translating said seed words to obtain a plurality of translated words corresponding to said seed word by looking up said machine-readable dictionary; and backward-translating said translated words to obtain a plurality of translated words in the first language corresponding to each of said plurality of translated words obtained by said step of forward-translating respectively, as words of the concept knowledge, by looking up said machine-readable dictionary.

U.S. Patent Application No. 20040117774 discloses a method and arrangement for handling case and other orthographic variations in linguistic databases by explicit representation comprising: explicit storage of all orthographic and case variations of words in the dictionary, and use of extended cut and paste codes to control dictionary size explosion and to make the restoration of the lemma more efficient. This provides the advantage of allowing very efficient handling of case and orthographic variants while performing a dictionary lookup.

U.S. Patent Application No. 20040243396 discloses a user-oriented electronic dictionary, an electronic dictionary system and a method for creating the same, in which users may freely modify (add or delete) attributes of a lemma in the electronic dictionary. In the present invention, the entity instances generated from an entity object are used to indicate the information related to a lemma in said electronic dictionary, and the relation instances generated from a relation object are used to indicate the directed relations between two entity instances. Therefore, in the electronic dictionary according to the present invention, all entity instances related to a lemma in said electronic dictionary are linked by the corresponding relation instances to form a directed relation graph. The electronic dictionary according to the present invention promises better reusability and maintainability.

U.S. Patent Application No. 20050027513 discloses a long character string, and when retrieving symbols containing characters of high frequency of appearance or character chain, high speed retrieval is possible up to infix matching and a symbol dictionary of small capacity can be compiled. In the symbol dictionary compiling method of the invention, each symbol in symbol data is covered with shorter symbols called “meta-symbols” for covering the symbol in the symbol data, and the information showing how each symbol is covered is obtained by preparing meta-symbol appearance information recorded in each meta-symbol, and therefore high speed retrieval including up to infix matching is possible, and a symbol dictionary of small capacity can be compiled.

While there have been a number of prior art systems for electronic dictionary and word lookups, they have had a number of shortcomings. Initially, they usually do not work with ‘any arbitrary machine readable text’. (For example, they do not support documents that come from ‘copy and paste operations’ of web pages.) These systems have typically also not permitted the independent deployment of dictionaries and context resources nor the simultaneous use of these resources to bear simultaneously.

These prior art systems have also not addressed in a ‘general way’ the requirement to have both content (dictionary meanings) and context (positional dependant meanings) data available to the user and thus provide both necessary and sufficient information to derive significant meaning from arbitrary text. They usually do not have a ‘general database structure’ to store individual sound clips for words and sentences. (They usually use speech synthesis which suffers from a number of shortcomings mostly to do with quality and limitations with foreign languages.)

They usually do not have a ‘general technique’ to do synchronized recording for both dictionary and content resources associated with arbitrary computer readable text. They further do not permit easy annotation of multiple definitions of a dictionary word to show which specific set of definitions apply for the specific context of a word in a document.

It is a principal object of the present invention to provide a literacy software system which overcomes these shortcomings and provides a comprehensive and robust literacy automation system. These and other objects of the invention will become apparent from the detailed description which follows.

### SUMMARY OF THE INVENTION

A method for creating and automating text definitions comprising the following steps: selecting a word to be defined; selecting a plurality of dictionaries and comparing the word to content of the dictionary; determining the root of the word; creating a list of words, including the root; and creating a plurality of related words from the root.

The method of claim 1 further comprising the step of providing the definition in a user readable format. A method for creating and automating text definitions comprising the following steps: selecting a word to be defined; selecting a plurality of dictionaries and comparing the word to content of the dictionary; determining the root of the word; creating a list of words, including the root; and creating a plurality of related words from the root.

A method for creating and automating text definitions comprising the following steps: selecting a word to be defined; selecting a plurality of dictionaries and comparing the word to content of the dictionary; determining the root of the word; creating a list of words, including the root; and creating a plurality of related words from the root.

### DESCRIPTION OF THE DRAWINGS

FIG. 1 is a block diagram of a system for use in the present invention.

FIGS. 2 and 2a illustrate the user screens of the present invention.

FIG. 3 is a flow diagram of the present invention.

FIG. 4 illustrates user screens which show the dictionary of the present invention.

FIG. 5 is a user screen showing a more detailed embodiment of the invention.

### BRIEF DESCRIPTION OF THE PREFERRED EMBODIMENT

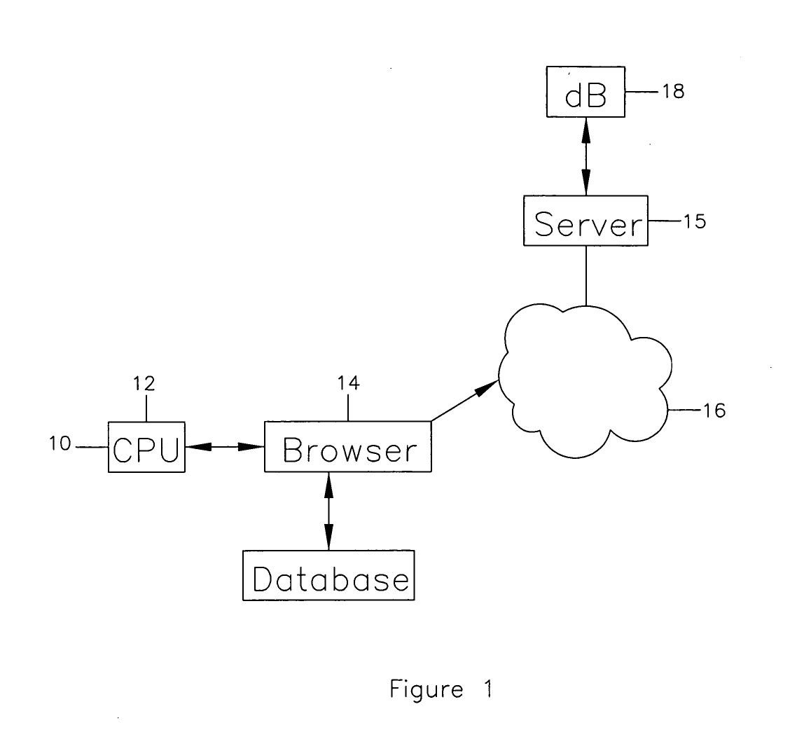

The present invention is described with reference to the enclosed Figures herein. Referring to FIG. 1, the operational environment of the present invention is shown. The system includes a workstation 10 with an operating system 12. The workstation will typically have an internet browser 14 and be connected to the Internet 16.

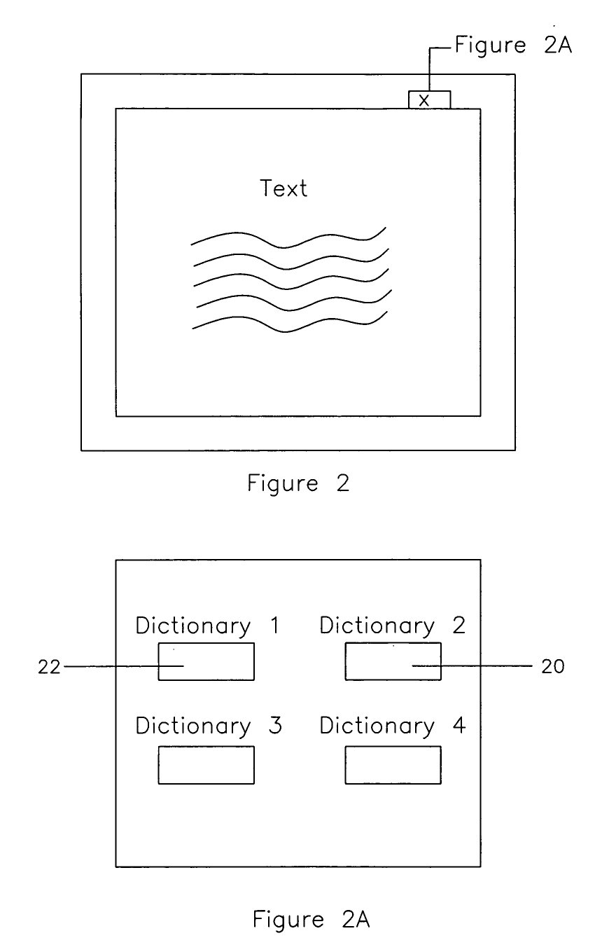

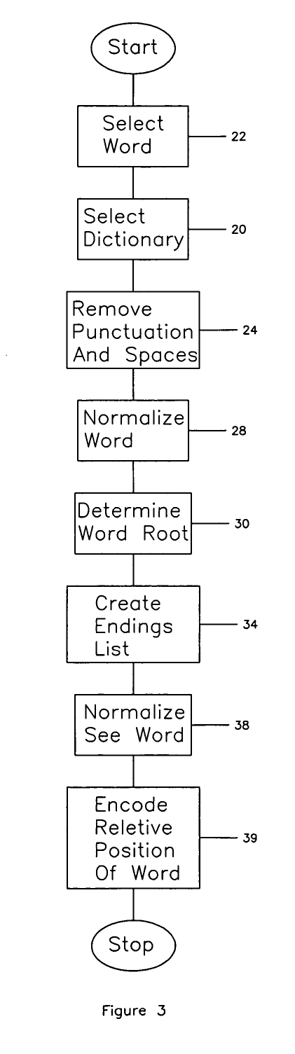

The system of the present invention will include a resident software program which will reside on the end user system 10 and be connected to the Internet 16. A server 15 will host or have access to a plurality of dictionaries or other related resources and databases 18. As shown in FIGS. 2, 2A, and 3 the system may connect to a plurality of databases 18 which requires the user to select one or more dictionaries as the starting point. Those dictionaries each have a separate ‘definition’ display area 20 to display the results of the lookups. Each definition display area can show text in a different language and/or a different font.

The section referring to the word to be defined is then hyper-text and then the following operations are performed. The word needs to be placed in either upper or lower case 22. Selection needs to have leading and trailing punctuation and spaces removed 24.

The lookup process involves converting the word from the form found in the text (un-normalized form) to a form consistent with the available headwords in which the dictionary words are organized for storage and retrieval 26.

The word normalization process requires the following operations. First, the system will check to see if the un-normalized word is already in headword form before doing any transformations 28. This is accomplished by doing a search of the dictionary headwords entries.

The root of the word needs to be determined 30. This is done by removing one character at a time from the end of the word 32. This process is called Root Derivation.

Next, the ‘endings list’ for the particular language (for example in English the endings would include: helper, helps, helping, helped, etc.) is used to generate all of the legal forms of a word 34. Each word in turn is looked up against the dictionary headwords after the ending has been added. This process is called Ending Expansion.

The process of Root Derivation and Ending Expansion is repeated until a headword version of the selected word is found or the Root Derivation terminates by running out of characters to remove 31. (Ending Expansion actually is the first operation after the initial lookup.)

The ‘see word’ normalization case needs to be handled 38. Most dictionaries carry the irregular forms of words as separate headwords. These entries simply have a ‘see xxxx’ entry as the definition. The relative position of the word is then encoded. 39.

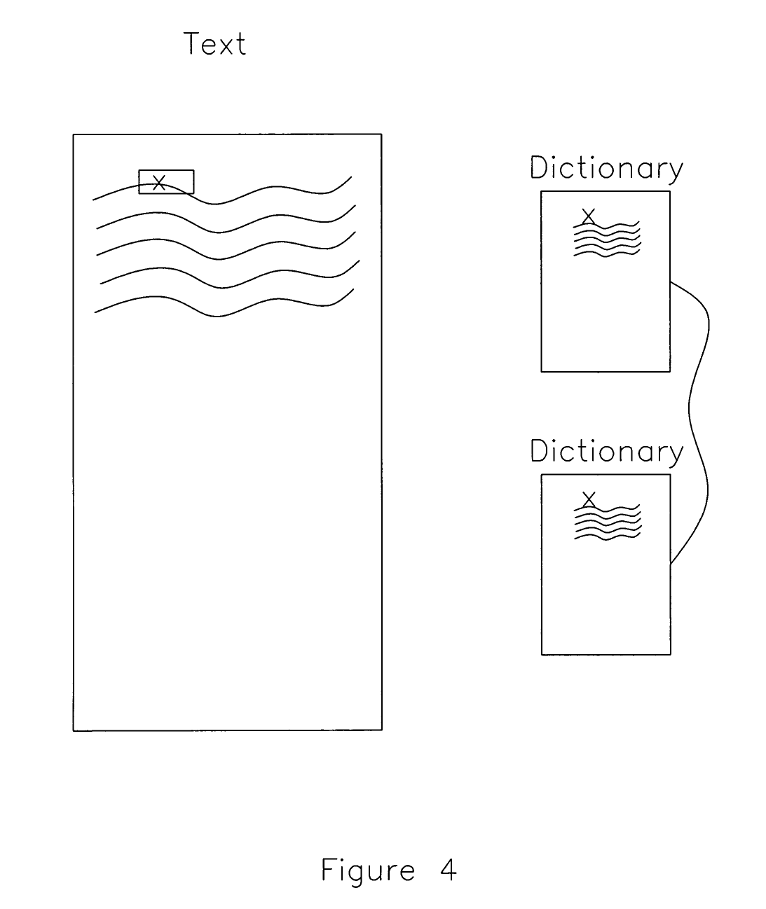

As shown in FIG. 4, the software permits users to hyper-select any word in a definition recursively without limit. This solves two problems: first it permits ‘see’ irregular entries to be easily resolved to the proper headword that has the definitions, and secondly it permits the user to find the meaning of words in definitions that they do not understand.

The software also encodes the relative position of the word in the document in which the selection occurs. This permits lookups into Annotation Resources based on this positional information. These resources can include context markers for showing which definitions apply to this word because of the surrounding words (or context) of usage. It also permits the creation of resource databases consisting of the recorded speech for any word or phrase. Finally, the positional information can be used to provide illustrations (images) keyed to the context of the word.

The software permits multiple definitions in multiple languages using multiple fonts. The invention also permits images and speech to be part of each definition. The invention will have a voice recognition package which will track spoken test. As the text appears on the text, a single click will resolve the selected word into headword form for simultaneous lookups in multiple dictionaries and show the resulting definitions. Positional information from the selection process is used to access one or more annotation resource databases.

The Literacy Automation tools are different from Internet Browser HyperText technology because the selections do not require an exact link to be embedded in the source document. The selections, by contract, are always transformed into a normalized headword form. Relative text position (context) information is always part of the selection process. The use of simultaneous resources for individual headword resolution is fully supported. Selections can be resolved to both dictionary content and context annotation resources.

The literacy Automation Software resolves selections to dictionary content or context resources with no intermediary documents or applications other than the dictionary and context management systems.

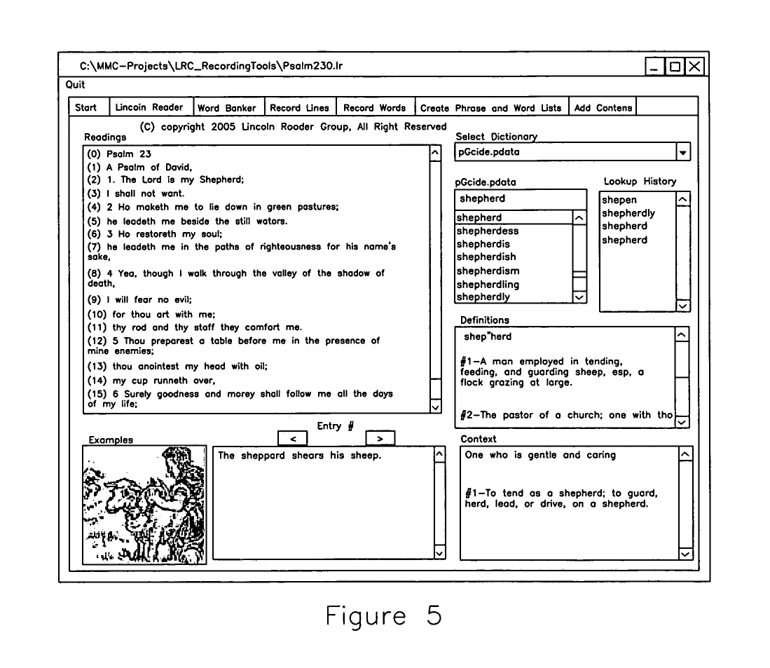

A more detailed embodiment of the invention is shown in FIG. 5 in the context of a biblical reading.

1. The ‘readings’ appear in the scrollable text box in the upper-left portion of the screen. This text (Psalm 23) has been divided in phrases. The phrases are neither on verse or sentence boundaries but are organized by distinct ‘ideas.’ Phrase boundaries are arbitrary and can be easily changed.

2. Clicking on a word will cause it to be spoken clearly. Clicking on a phrase marker (between braces: [2]) will cause it to be spoken clearly and fluently. There is also an option to hear all the words in a phrase spoken ‘distinctly’ (one word at a time with a slight pause between each one).

3. There may be several dictionaries available to the User for any given reading. In this case, the dictionary selected is called the GCIDE: “Gnu Collaborative International Dictionary of English.” When any word is selected (shepherd above), the word is looked up in the dictionary. All of the definitions appear in the scrollable text definitions window. The word is also positioned in the list of headwords. Words previously looked up appear in the Lookup History list. It is therefore easy to go back and look up a word again. Words in the definition window can also be looked up by clicking on them. (This is called ‘recursion’).

4. The ‘context’ text box presents any comment appropriate for a word as sued in a particular location within the text. It also might include a copy of the definition most appropriate for this particular instance and use.

5. Many words have a number of examples and illustrations to make them easier to understand for novices. There can be up to ten images and sentences to make a word easy to understand.

6. The tab entries across the top of the screen are visible only to show the infrastructure available to create highly annotated text readings. These would not appear when the Lincoln Reading is used by a student.

7. It takes under ten minutes to create a list of recorded words and phrases for Psalm 23 using the tools indicated by the tabs.

8. The Glossary (from Science and Health) has been put into ‘database dictionary form’ for use by the LR. (Only for a demonstration for TMC).

While the preferred embodiments of the present invention have been described and illustrated, modifications may be made by one of ordinary skill in the art without departing from the scope and spirit of the invention as defined in the appended claims.

1. A method for creating and automating text definitions comprising the following steps:
selecting a word to be defined;
selecting a plurality of dictionaries and comparing the word to content of the dictionary;
determining the root of the word;
creating a list of words, including the root; and
creating a plurality of related words from the root.

2. The method of claim 1 further comprising the step of providing the definition in a user readable format.

3. A method for creating and automating text definitions comprising the following steps:
selecting a section of text;
selecting a word to be defined;
selecting a plurality of dictionaries and comparing the word to content of the dictionary;
determining the root of the word;
creating a list of words, including the root; and
creating a plurality of related words from the root.

4. A method for creating and automating text definitions comprising the following steps:
selecting a section of text;
selecting a plurality of words to be defined;
selecting a plurality of dictionaries and comparing the words to content of the dictionary;
determining the root of the words;
creating a list of words, including the root; and
creating a plurality of related words from the root.
